(19) United States
(12) Patent Application Publication
(10) Pub. No.: US 2022/0403203 A1
(43) Pub. Date: Dec. 22, 2022

(54) Water Vapor Barrier Coating Composition

(71) Applicant: Mantrose-Haeuser Co., Inc., Lincoln, RI (US)

(72) Inventors: Stanislav E. Solovyov, North Providence, RI (US); Arun K. Uppalanchi, Cumberland, RI (US); Paul J. Pothier, Warwick, RI (US); Bin Zhong, North Attleborough, MA (US)

(21) Appl. No.: 17/807,242

(22) Filed: Jun. 16, 2022

Related U.S. Application Data
(60) Provisional application No. 63/212,433, filed on Jun. 18, 2021.

(51) Int. Cl. C09D 129/06; C09D 5/00; C09D 5/14; D21H 19/12; D21H 23/70; D21H 27/10

(52) U.S. Cl. CPC C09D 129/06; C09D 5/00; C09D 5/14; D21H 19/12; D21H 23/70; D21H 27/10

(57) ABSTRACT

Described herein is a water vapor barrier coating composition that is especially useful for paper-based packaging applications. The composition includes a basecoat layer and a topcoat layer that are applied to fibrous substrates in sequential order as aqueous coatings. The basecoat layer is applied and dried and then the topcoat layer is applied and dried. The basecoat layer includes an aqueous solution of ethylenically modified polyvinyl alcohol and optionally a plasticizer. The topcoat layer includes an aqueous polymeric dispersion or emulsion, compatibilized with the base layer by adding a small percentage of ethylenically modified polyvinyl alcohol solution, and optionally a viscosity modifier, defoamer, release agent, slip agent, crosslinker, and/or anti-blocking additive. The composition includes a synergistic interaction between the basecoat and the topcoat. The composition is optionally biodegradable and/or compostable, along with a coated paper stock, without the need to separate and reprocess the coating.

### CROSS-REFERENCE TO RELATED APPLICATIONS

This application claims priority to U.S. Provisional Application No. 63/212,433, filed Jun. 18, 2021, which is hereby incorporated by reference herein.

### FIELD OF DISCLOSURE

Described herein are water vapor barrier coatings for packaging applications, and more particularly, water-based coatings on paper, paperboard, molded fiber, molded starch, and other fibrous substrates. The water vapor barrier coatings may be used on substrates made with renewable sources of fiber, such as wood pulp, bagasse, grass, bamboo, hemp, an agricultural fiber source, coated paper, paper coated with nanofiber cellulose, paper coated with microfibrillated cellulose, and combinations thereof. Applications of the water vapor barrier coatings include packaging articles for frozen, refrigerated, and ambient storage foods, pharmaceutical products, cosmetics, and other consumer goods, especially those applications requiring high levels of water vapor barrier protection during distribution and storage. The loss of moisture and the excessive drying of frozen and refrigerated foods packaged in paper and molded fiber containers have prevented a wide acceptance of such packaging in the market. Also described herein are environmentally responsible barrier coatings on renewable biosourced packaging materials, with such coatings being biodegradable and/or compostable along with the coated substrate.

### BACKGROUND

With growing world-wide concerns about plastic packaging waste and ways to reduce it, there is an increasing interest in replacing plastics with renewable, recyclable, biodegradable, compostable paper-based packaging. Fibrous cellulose-based substrates, such as paper, are produced from renewable bioresources and are widely used in packaging. Such fibrous substrates can be produced in sheet and roll form, and can be paper, paperboard, molded fiber containers, and/or other fiber-based materials. Typically, fibrous substrates provide poor resistance to water vapor, gases, oil, solvents, and greases. Various internal wet end sizing agents or surface sizing agents are used in papermaking to make paper more hydrophobic and to improve its water resistance. The use of many of these chemistries is increasingly regulated in packaging applications because of the toxicity of such chemicals and because of documented migration of these compounds into foodstuffs from paper and paper coatings. The use of such additives and coatings also negatively affects recyclability and biodegradability of paper, often making such paper unsuitable for composting and direct disposal in landfills.

In addition, various chloro- and fluorochemical additives have been long used for paper sizing and in paper coatings to improve paper resistance to oil, grease, and water. With the growing efforts by the paper industry to phase out these chemicals, environmentally responsible alternatives have been actively sought. Complete elimination of chloro- and fluorochemicals from paper and providing a sustainable, environmentally responsible water-based coating solution for paper-based packaging, requiring a high level of water vapor barrier protection, was one of the driving forces behind the present disclosure.

To improve their resistance to water uptake and water vapor permeation, fibrous substrates have been coated with a wide variety of barrier compositions, particularly when the substrates are used for packaging food. In particular, extrusion- or vacuum lamination of polyethylene and other hydrophobic thermoplastics to paper substrates has been used. Whereas these methods improve water vapor barrier and water resistance of paper, the inherent limitations of the film extrusion process make it impossible to produce a uniform coating layer thinner than 15-25 microns, as well as to coat 3-D shaped articles, such as molded fiber. In addition, polyethylene coated paper is not biodegradable or compostable, and it is increasingly being subjected to regulations for plastic packaging. Other ways to improve water resistance of paper substrates include coating the paper substrates with water-based or solvent-based dispersions and emulsions of various resin latexes, such as polyesters, polyacrylates and acrylic copolymers, styrene-butadiene copolymers, polyhydroxyalkanoates (PHA), vinyl acetate-ethylene copolymers, paraffin and ester waxes. Such coatings are often unable to provide a desirable level of water vapor barrier protection for many packaging applications, and many of them are also being increasingly regulated when used in direct food contact.

There is an unmet need for environmentally responsible, lightweight, high water vapor barrier coatings for fiber-based packaging applications. Water-based coating formulations provide an additional benefit for commercial use by eliminating harsh chemical solvents and the need to control residual solvent levels in the finished product.

Polyvinyl alcohol resins (PVOH) are water soluble semicrystalline polymers, which are known to provide exceptional oxygen barrier protection when dry. However, being water soluble, they exhibit almost no resistance to water and water vapor permeation. Water acts as a plasticizer in the PVOH matrix, disrupting hydrogen bonding between adjacent hydroxyl groups, dissolving PVOH crystalline segments, and swelling amorphous regions, thus facilitating water vapor diffusion. For these reasons, PVOH has not been contemplated for use in water vapor barrier packaging.

Steady-state water vapor transmission rates (WVTR) of biaxially oriented standalone PVOH films exposed to various relative humidity (RH) levels on one side and to 0% RH on the other side have been reported (Chen et al., Effects of Temperature and Humidity on the Barrier Properties of Biaxially-oriented Polypropylene and Polyvinyl Alcohol Films, The Journal of Applied Packaging Research 6(1): 40-46, June 2014). Surprisingly, the biaxially oriented PVOH film provided a lower WVTR than a biaxially oriented polypropylene (BOPP) film of comparable thickness at the same temperature and at up to 70% RH on the film side exposed to high RH (the wet side). At up to 65% RH, the PVOH film exhibited a nearly linear dependence of WVTR on the RH difference, similar to that of nonpolar polymers like polyethylene and other polyolefins. Above 65% RH, the PVOH resin was plasticized by water and the WVTR of the PVOH film exponentially increased with RH as expected. The WVTR of the PVOH film was also found to be less sensitive to temperature changes than the WVTR of the BOPP film, presumably due to a higher polarity and stronger intermolecular bonding of PVOH.

PVOH resins are commercially produced by hydrolysis of polyvinyl acetate, which is generally produced via a free radical polymerization process as an atactic polymer. Despite most commercial PVOH resins being atactic, they possess a strong tendency to crystallize when dried, unlike other atactic polymers with bulky side groups. It is known that fully and super hydrolyzed PVOH grades, where nearly all acetate groups have been substituted by hydroxyl groups, can achieve the highest degrees of crystallinity up to 50-55% (Basic Physical Properties of PVOH Resin, Kuraray Co. Ltd. technical bulletin, December 2020). Heat treatment of PVOH films at temperatures of 150-200° C. is also known to promote PVOH crystallization. However, exposing PVOH to temperatures above 200° C. causes rapid thermal degradation of the polymer. As with other polymers, increasing the degree of PVOH crystallinity generally improves its barrier properties, because crystalline domains in the polymer matrix are practically impermeable for most gases and vapors.

Ethylene-vinyl alcohol copolymers (EVOH) with 24-44 mol. % ethylene content are commercially produced extrudable thermoplastics. They offer a much higher level of resistance to water and can maintain their oxygen barrier properties at higher relative humidity; however, they are insoluble in water. On the other hand, ethylenically modified polyvinyl alcohols or, more specifically, ethylene-vinyl alcohol copolymers with 3-9 mol. % ethylene content, are water soluble polymers, which have been used in water resistant glue and adhesive formulations. Although they are more resistant to direct water contact, these low ethylene content EVOH resins are not known to possess high water vapor barrier properties, because they are subject to the same plasticization effects by water as PVOH.

As described herein, it has been found that water soluble, fully hydrolyzed EVOH copolymers with 3-9 mol. % ethylene content could be used in water-based coatings and that the dried unoriented films of such polymers could provide a very high water vapor barrier, provided that the dried coating possesses a high degree of crystallinity and it is not exposed to RH above 65%. Above 65% RH, there is an apparent transition from the linear dependence of WVTR on RH to an exponential increase with RH. EVOH resins are produced by hydrolysis of ethylene-vinyl acetate copolymer. Fully hydrolyzed EVOH grades with at least 98% degree of hydrolysis and, preferably, super hydrolyzed EVOH grades with at least 99.5% degree of hydrolysis, have the lowest concentration of residual acetate groups, and exhibit the highest level of hydrogen bonding and the highest degree of crystallinity in the dry state. Both these properties are essential for preventing plasticization and swelling of the EVOH matrix by water. Additional water resistance is provided by the hydrophobic ethylenic segments in EVOH, which apparently do not co-crystallize with PVOH segments and thus tend to concentrate in the amorphous regions during crystallization and to reduce water diffusion rates through these regions. The effective thickness (in μm) or the dry surface coverage (in g/m² or gsm) of such EVOH film on a fibrous substrate is selected based on the desired WVTR of the coating composition at the temperature of use and 65% RH to 0% RH difference between the internal and external environments. To ensure that the EVOH layer is never exposed to RH levels above 65%, it needs to be protected by a suitable topcoat barrier layer.

Since many packaged processed foods, cosmetics, and other products are moist and have a water activity of 0.7-0.9 and above, they consistently generate 70-90% and higher RH levels in the sealed package headspace. Such RH levels will compromise the water vapor barrier properties of the EVOH film if it is directly exposed to them as a part of a container or a lidstock. Therefore, an additional protective coating layer (a second coating) was contemplated to be applied over the EVOH basecoat layer. The primary purpose of such layer is to protect the EVOH layer from exposure to RH levels higher than 65%. As such, the second layer does not need to provide an exceptionally high water vapor barrier. Depending on the conditions of use, the second layer may only need to reduce RH from 70-90% outside to 65% at the EVOH layer interface. The measured WVTR of the standalone film of certain thickness, made from the topcoat layer composition, can be used as a guide for the second layer thickness selection, provided that the selected composition exhibits a linear dependence of its WVTR on RH. The second coating may also provide additional desirable end use properties, such as heat sealability, gloss, scratch resistance, antifogging, antiblocking, slip, regulatory clearance for direct food contact, and others, generally unavailable from the EVOH basecoat. Water-based dispersions and emulsions of various food contact grade polymers, paraffin and ester waxes, and their mixtures can be used as coatings for forming the second layer of the presented composition.

### BRIEF DESCRIPTION OF THE DISCLOSURE

In one aspect, described herein is a water vapor barrier coating composition comprising a basecoat layer comprising a dried aqueous solution of ethylenically modified polyvinyl alcohol; and a topcoat layer comprising a dried aqueous polymeric dispersion or emulsion.

In another aspect, described herein is a water vapor barrier coating composition comprising a basecoat layer comprising an aqueous solution of ethylenically modified polyvinyl alcohol; and a topcoat layer comprising an aqueous polymeric dispersion or emulsion; wherein, upon application to a fibrous substrate, the basecoat layer is applied onto the fibrous substrate and subsequently dried before the topcoat layer is applied onto the basecoat layer and subsequently dried.

In another aspect, described herein is a water vapor barrier coating composition comprising a basecoat layer comprising ethylenically modified polyvinyl alcohol; and a topcoat layer comprising a polymer; wherein the water vapor barrier coating composition is prepared according to a method comprising (i) applying an aqueous solution of ethylenically modified polyvinyl alcohol onto a fibrous substrate; (ii) drying the aqueous solution to form the basecoat layer; (iii) applying an aqueous polymeric dispersion or emulsion onto the basecoat layer; and (iv) drying the aqueous polymeric dispersion or emulsion to form the topcoat layer.

In another aspect, described herein is a method of applying a basecoat of the water vapor barrier coating composition and/or a topcoat of the water vapor barrier coating composition.

In yet another aspect, described herein is a method of using the water vapor barrier coating composition to reduce a water vapor transmission rate of a coated substrate.

### BRIEF DESCRIPTION OF THE DRAWINGS

The figures are examples of compositions in accordance with the present disclosure and are not to be construed as limiting.

FIG. 1 is a graphical depiction of an exemplary embodiment of WVTR dependence on the EVOH dry basecoat weight (g/m²) in accordance with the present disclosure.

FIG. 2A is a graphical depiction of an exemplary embodiment of WVTR of the basecoat alone and the basecoat with the topcoat vs. the RH difference between the shown RH value and 0% RH in accordance with the present disclosure. Basecoats (B) with 4.9 and 5.3 gsm dry coat weights were used, and topcoats (T) with 15.9 and 18.0 gsm dry coat weights were applied over them. The y-axis scaling is linear.

FIG. 2B is a graphical depiction of an exemplary embodiment of WVTR of the basecoat alone and the basecoat with the topcoat vs. the RH difference between the shown RH value and 0% RH in accordance with the present disclosure. Basecoats (B) with 4.9 and 5.3 gsm dry coat weights were used, and topcoats (T) with 15.9 and 18.0 gsm dry coat weights were applied over them. The y-axis scaling is logarithmic.

FIG. 3 is a graphical depiction of an exemplary embodiment of WVTR of the B4.9+T15.9 composition vs. the RH difference between the shown RH value and 0% RH, demonstrating the synergistic effect of the disclosed basecoat/topcoat coating system on the WVTR by comparing the experimental WVTR values with theoretically predicted values, in accordance with the present disclosure.

FIG. 4 is a graphical depiction of an exemplary embodiment of a schematic of a steady state RH profile across the coated substrate cross-section in accordance with the present disclosure.

### DETAILED DESCRIPTION OF THE DISCLOSURE

The following detailed description is exemplary in nature and is not intended to limit the described embodiments or the application and uses of the described embodiments. Furthermore, there is no intention to be bound by any expressed or implied theory presented in the preceding background, the summary, or the following detailed description.

Generally, the present disclosure is directed to water vapor barrier coating compositions, basecoats of water vapor barrier coating compositions, topcoats of water vapor barrier coating compositions, methods of applying water vapor barrier coating compositions, methods of applying basecoats of water vapor barrier coating compositions, methods of applying topcoats of water vapor barrier coating compositions, and methods of using water vapor barrier coating compositions, methods of using basecoats of water vapor barrier coating compositions, and methods of using topcoats of water vapor barrier coating compositions. The water vapor barrier coating compositions in accordance with the present disclosure are especially useful for coating fibrous substrates and packaging articles made from fibrous substrates.

Water Vapor Barrier Coating Compositions.

In many embodiments, the water vapor barrier coating composition comprises a basecoat layer comprising a dried aqueous solution of ethylenically modified polyvinyl alcohol; and a topcoat layer comprising a dried aqueous polymeric dispersion or emulsion.

In many embodiments, the water vapor barrier coating composition comprises a basecoat layer comprising an aqueous solution of ethylenically modified polyvinyl alcohol; and a topcoat layer comprising an aqueous polymeric dispersion or emulsion; wherein, upon application to a fibrous substrate, the basecoat layer is applied onto the fibrous substrate and subsequently dried before the topcoat layer is applied onto the basecoat layer and subsequently dried.

In many embodiments, the water vapor barrier coating composition comprises a basecoat layer comprising ethylenically modified polyvinyl alcohol; and a topcoat layer comprising a polymer; wherein the water vapor barrier coating composition is prepared according to a method comprising (i) applying an aqueous solution of ethylenically modified polyvinyl alcohol onto a fibrous substrate; (ii) drying the aqueous solution to form the basecoat layer; (iii) applying an aqueous polymeric dispersion or emulsion onto the basecoat layer; and (iv) drying the aqueous polymeric dispersion or emulsion to form the topcoat layer.

In some embodiments, the aqueous solution is a water-based solution.

In some embodiments, the water vapor barrier coating composition comprises a basecoat layer and a topcoat layer. In some embodiments, water vapor barrier coating composition comprises at least one layer, at least two layers, at least three layers, at least four layers, at least five layers, at least six layers, at least seven layers, or at least eight layers. In some embodiments, water vapor barrier coating composition consists of two layers. In some embodiments, the basecoat layer is produced by sequential application of the ethylenically modified PVOH solution in the form of two, three, or four layers. In some embodiments, the topcoat layer is produced by sequential application of one polymeric dispersion or emulsion in the form of two, three, or four layers. In some embodiments, the topcoat layer is produced by sequential application of multiple polymeric dispersions or emulsions as individual layers in the form of two, three, or four layers.

The compositions according to the present disclosure include a synergistic interaction between the basecoat and the topcoat. In these embodiments, the topcoat serves to reduce RH at the basecoat-topcoat layer interface and to maintain the low WVTR of the basecoat by eliminating its exposure to excessively high humidity.

In some embodiments, the basecoat layer is dried by exposure to hot air or infrared radiation heating or ultrasonic heating or photonic heating or a steam-heated drying roll heating/drying system, or combinations thereof. In some embodiments, the basecoat layer is dried by exposure to hot air or infrared radiation heating.

In some embodiments, the basecoat layer is dried by exposure to hot air or infrared radiation heating or ultrasonic heating or photonic heating or a steam-heated drying roll heating/drying system, or combinations thereof at a temperature of at least 100° C., at least 105° C., at least 110° C., at least 115° C., at least 120° C., at least 125° C., at least 130° C., at least 135° C., at least 140° C., at least 145° C., or at least 150° C. In some embodiments, the basecoat layer is dried by exposure to hot air or infrared radiation heating or ultrasonic heating or photonic heating or a steam-heated drying roll heating/drying system, or combinations thereof at a temperature of at least 110° C. In some embodiments, the basecoat layer is dried by exposure to hot air or infrared radiation heating or ultrasonic heating or photonic heating or a steam-heated drying roll heating/drying system, or combinations thereof at a temperature of at least 125° C.

In many embodiments, the basecoat layer is dried by exposure to hot air or infrared radiation heating or ultrasonic heating or photonic heating or a steam-heated drying roll heating/drying system, or combinations thereof for any suitable amount of time known in the art. Suitable drying times depend on wet coat weight, water weight percentage in the coating solution, and chemical identity of the basecoat layer. Generally, persons skilled in the art will select appropriate drying times. In some embodiments, the basecoat layer is dried by exposure to hot air or infrared radiation heating or ultrasonic heating or photonic heating or a steam-heated drying roll heating/drying system, or combinations thereof for a time of at least about 1 second, 2 seconds, 3 seconds, 4 seconds, 5 seconds, 6 seconds, 7 seconds, 8 seconds, or 9 seconds to about 10 seconds, 20 seconds, 30 seconds, 40 seconds, 50 seconds, 60 seconds, 70 seconds, 80 seconds, 90 seconds, 120 seconds, 150 seconds, 180 seconds, 210 seconds, 240 seconds, 270 seconds, or 300 seconds. In some embodiments, the basecoat layer is dried by exposure to hot air or infrared radiation heating or ultrasonic heating or photonic heating or a steam-heated drying roll heating/drying system, or combinations thereof for a time in a range of from about 1 second to about 300 seconds. In some embodiments, the basecoat layer is dried by exposure to hot air or infrared radiation heating or ultrasonic heating or photonic heating or a steam-heated drying roll heating/drying system, or combinations thereof for a time in a range of from about 1 second to about 10 seconds.

In some embodiments, the topcoat layer is dried by exposure to hot air or infrared radiation heating or ultrasonic heating or photonic heating or a steam-heated drying roll heating/drying system, or combinations thereof. In some embodiments, the topcoat layer is dried by exposure to hot air or infrared radiation heating.

In some embodiments, the topcoat layer is dried by exposure to hot air or infrared radiation heating or ultrasonic heating or photonic heating or a steam-heated drying roll heating/drying system, or combinations thereof at a temperature of at least 100° C., at least 105° C., at least 110° C., at least 115° C., at least 120° C., at least 125° C., at least 130° C., at least 135° C., at least 140° C., at least 145° C., or at least 150° C. In some embodiments, the topcoat layer is dried by exposure to hot air or infrared radiation heating or ultrasonic heating or photonic heating or a steam-heated drying roll heating/drying system, or combinations thereof at a temperature of at least 110° C. In some embodiments, the topcoat layer is dried by exposure to hot air or infrared radiation heating or ultrasonic heating or photonic heating or a steam-heated drying roll heating/drying system, or combinations thereof at a temperature of at least 125° C.

In many embodiments, the topcoat layer is dried and/or cured by exposure to hot air or infrared radiation heating or ultrasonic heating or photonic heating or a steam-heated drying roll heating/drying system, or combinations thereof for any suitable amount of time known in the art. Suitable drying/curing times depend on wet coat weight, water weight percentage in the coating dispersion or emulsion, and chemical identity of the topcoat layer. Generally, persons skilled in the art will select appropriate drying/curing times. In some embodiments, the topcoat layer is dried and/or cured by exposure to hot air or infrared radiation heating or ultrasonic heating or photonic heating or a steam-heated drying roll heating/drying system, or combinations thereof for a time of at least about 1 second, 2 seconds, 3 seconds, 4 seconds, 5 seconds, 6 seconds, 7 seconds, 8 seconds, or 9 seconds to about 10 seconds, 20 seconds, 30 seconds, 40 seconds, 50 seconds, 60 seconds, 70 seconds, 80 seconds, 90 seconds, 120 seconds, 150 seconds, 180 seconds, 210 seconds, 240 seconds, 270 seconds, or 300 seconds. In some embodiments, the topcoat layer is dried and/or cured by exposure to hot air or infrared radiation heating or ultrasonic heating or photonic heating or a steam-heated drying roll heating/drying system, or combinations thereof for a time in a range of from about 1 second to about 300 seconds. In some embodiments, the topcoat layer is dried and/or cured by exposure to hot air or infrared radiation heating or ultrasonic heating or photonic heating or a steam-heated drying roll heating/drying system, or combinations thereof for a time in a range of from about 1 second to about 10 seconds.

In some embodiments, the topcoat layer comprises a water-based dispersion or emulsion of one or more polymers selected from the group consisting of polyesters, polyacrylates and acrylic copolymers, polyvinyl acetate, styrene-butadiene copolymers, polyhydroxyalkanoates, vinyl acetate—ethylene copolymers, and a water-based emulsion of paraffin and ester waxes. In some embodiments, the water-based dispersion or emulsion is modified with up to 2 wt. %, on solid-on-solid basis, of a solution comprising an aqueous solution of water-soluble ethylene-vinyl alcohol copolymer with at least 98% degree of hydrolysis, containing 3-9 mol. % of ethylene; a biocide; and optionally a plasticizer.

In many embodiments, the topcoat comprises any suitable additive known in the art. In some embodiments, the topcoat comprises an additive selected from the group consisting of viscosity modifiers, defoamers, pH regulators, release agents, slip agents, anti-blocking additives, crosslinkers, and combinations thereof. Generally, these additives are selected depending on the type of coated substrate, the process, and end-use application requirements.

Different topcoat formulations will have different WVTR's for the same dry topcoat layer thickness at the intended conditions of use. Therefore, the dry topcoat layer thickness or the dry topcoat surface coverage is adjusted for each application and the intended conditions of use so that the dry topcoat layer provides a sufficient level of water vapor barrier protection to the basecoat by having a specific WVTR. The dry topcoat is deemed to provide a sufficient level of water vapor barrier protection if it can reduce the RH to 65% or lower at the topcoat-basecoat layer interface at the intended conditions of use. In some embodiments, the topcoat layer has a water vapor transmission rate (WVTR) for a specific uniform single layer thickness at the conditions of use, is applied at the dry surface coverage in g/m² or at the dry layer thickness in micrometers, and is exposed to a high RH environment; wherein the thickness is selected to reduce relative humidity at the basecoat layer interface with the topcoat layer to at least 65% or lower.

In some embodiments, the water vapor barrier coating composition comprises two water-based coating layers that are sequentially applied to, and dried on, a substrate. In these embodiments, the first coating, forming the basecoat layer, comprises a solution of at least 98% hydrolyzed EVOH resin with 3-9 mol. % ethylenic content in water, optionally a biocide, and optionally a plasticizer. The biocide is used to extend the shelf life of the EVOH basecoat solution in storage if it is not used immediately after it is made. The plasticizer is used to improve flexibility of thicker coatings. The second coating, forming the topcoat layer, comprises a water-based dispersion or emulsion of polyesters, polyacrylates and acrylic copolymers, polyvinyl acetate, styrene-butadiene copolymers, polyhydroxyalkanoates, vinyl acetate-ethylene copolymers, paraffin and ester waxes, or mixtures thereof, modified by the addition of up to 2 wt. % of the EVOH resin with 3-9 mol. % ethylenic content on the solid-on-solid weight basis. The added EVOH solution improves wettability of the dried basecoat layer and its compatibility with the topcoat layer, thereby preventing formation of pinholes, incomplete wetting, layer delamination, and other coating defects in commercial operations. The second coating may also contain an optional viscosity modifier additive, a defoamer, a pH regulator, a release agent, a slip additive, an anti-blocking additive, a crosslinker, or any combination thereof.

In some embodiments, the basecoat layer comprises an aqueous solution of water-soluble ethylene-vinyl alcohol copolymer with at least 98% degree of hydrolysis, containing 3-9 mol. % of ethylene; a biocide, and optionally a plasticizer. In some embodiments, the basecoat layer consists essentially of an aqueous solution of ethylenically modified polyvinyl alcohol.

In some embodiments, the plasticizer is selected from the group consisting of glycerol, a polyol having a higher molecular weight than glycerol, a water-soluble polyethylene glycol, and propylene glycol.

Generally, the thickness of the dry EVOH basecoat layer is selected to provide the desired WVTR at the desired temperature, using the EVOH WVTR data at 65% RH (i.e. at 65% to 0% RH difference across the sample). Typically, 1-20 dry gsm EVOH basecoat weights are applied. Since the composition is expected to be exposed to RH levels above 65%, the thickness of the dry topcoat layer is selected to provide the WVTR drop from RH in the high RH environment to 65%, using the dried topcoat WVTR data at the desired temperature and the RH difference at the RH conditions comparable to those of the actual application. A typical topcoat application rate varies within 3-20 dry gsm. The combination of the basecoat and the topcoat produces a synergistic effect by keeping the EVOH layer at or below the threshold RH, beyond which the water vapor barrier properties of the EVOH layer are rapidly degraded. By keeping the EVOH layer below 65% RH, its degree of crystallinity is maintained, disruption of EVOH hydrogen bonding is avoided, and plasticization and swelling by water are practically eliminated. Thus, with the two-layer composition it becomes possible to obtain the full benefit of low WVTR of the dry EVOH layer, even though the topcoat layer is exposed to high RH levels. The water vapor transmission rate of the composition is comparable to or better than that of stand-alone polyolefin plastic films of similar thickness for a wide range of temperatures and relative humidity.

Basecoat Layer.

It is known in the art that water soluble EVOH resins with low ethylene content provide a relatively higher resistance to water compared to PVOH resins. But it was surprisingly discovered herein that such EVOH resins may serve as an effective water vapor barrier if they are kept below certain relative humidity levels. Despite a relatively higher water resistance of EVOH, it was not anticipated that highly polar, water soluble resins like PVOH and EVOH could effectively block permeation of water vapor. PVOH resins in particular are known to have a highly nonlinear dependence of their water vapor permeability (WVP) on RH, which increases exponentially with RH above approximately 65%. However, it is not generally recognized that they also provide very low WVP values below 65% RH, and, in particular, that below 65% RH their WVP dependence on RH difference is close to being linear. Below 65% RH, both oriented and unoriented PVOH films exhibit WVTR values that are lower than those of polyethylene and polypropylene films of comparable thickness. The present disclosure recognizes this fact and further improves upon it, by demonstrating the use of water soluble EVOH resins with low ethylenic content as a primary water vapor barrier layer instead of PVOH. Being water soluble, such EVOH resins can be used in water-based coating formulations to apply a contiguous film basecoat on fibrous substrates, yet they produce very high water vapor barrier films after drying, if they are not exposed to excessively high humidity. The RH control in the EVOH basecoat layer is achieved by applying a suitable topcoat layer over the basecoat layer.

Another discovery of the present disclosure is recognition of the need to provide a specific level of water vapor barrier protection for the EVOH basecoat. The primary purpose of the topcoat is to provide the level of water vapor barrier protection for the basecoat, which effectively reduces RH at the basecoat-topcoat interface to about 65% RH or below. Alternatively, in some embodiments, if a contemplated topcoat layer cannot be designed to provide the required barrier for practical or economic reasons, a thicker EVOH base layer may be used instead, with the understanding that some part of that thickness will be exposed to RH levels exceeding 65%, and the remaining “dry” part will serve as the primary water vapor barrier and will determine the overall barrier performance of the composition. In these embodiments, the overall thickness of the basecoat should be selected to provide the desired water vapor barrier from the “dry” sublayer, kept below 65% RH, and the desired RH drop by the “wet” sublayer, exposed to 65% and higher RH. In these embodiments, the EVOH basecoat dry surface coverage typically varies within 5-25 gsm. Then, the corresponding topcoat layer surface coverage may be typically reduced to 2-20 gsm.

Due to the presence of nonpolar ethylenic segments in the EVOH polymer chain, WVTR of dried EVOH films is lower than that of PVOH films of the same thickness and degree of crystallinity. EVOH also offers an increased resistance to liquid water, i.e. lower water absorption and lower swelling. Fully hydrolyzed EVOH grades with at least 98% degree of hydrolysis contain a very small molar amount of residual acetate groups. That results in high degrees of PVOH segment crystallization upon drying, with minimal interference from bulky acetate groups. Partially hydrolyzed PVOH and EVOH grades with 70-90% degree of hydrolysis generally form a much smaller crystalline phase. Super hydrolyzed PVOH and EVOH grades, with at least 99.5% degree of hydrolysis, exhibit the highest crystallinity levels. Crystalline segments are considered to be practically impermeable to water vapor unless they are exposed to excessive water amounts and are melted and dissolved. Hydrophobic ethylenic segments in EVOH do not tend to co-crystallize with PVOH segments and are concentrated in the amorphous regions, thereby reducing the water vapor permeability of the amorphous phase in EVOH. Therefore, fully hydrolyzed water soluble EVOH resins with small ethylenic content offer a combination of a high degree of crystallinity and a water resistant, ethylene rich amorphous phase. In practical terms, EVOH with 3-9 mol. % ethylene content can be dissolved in water and contains enough ethylene to improve water vapor barrier vs. PVOH.

Apart from serving as the primary water vapor barrier, the EVOH basecoat layer provides additional benefits for end-use applications of the disclosed composition. These benefits include: excellent film forming and surface coverage on fibrous substrates, excellent oil, grease, and solvent resistance, high oxygen barrier, and high aroma barrier.

In some embodiments, the basecoat resin comprises at least 90%, at least 91%, at least 92%, at least 93%, at least 94%, at least 95%, at least 96%, at least 97%, at least 98%, at least 99%, at least 99.5%, or 100% hydrolyzed EVOH grades.

In some embodiments, the basecoat resin consists essentially of ethylenically modified polyvinyl alcohol. In some embodiments, the basecoat resin consists essentially of ethylenically modified polyvinyl alcohol and optionally a crosslinker. In some embodiments, the basecoat resin consists of ethylenically modified polyvinyl alcohol. It is preferred to minimize or to completely eliminate any additional components in the basecoat resin, as it was found that these components generally tend to degrade the water vapor barrier properties of the dried basecoat layer.

In some embodiments, the WVTR of the disclosed basecoat layer can be further reduced and its resistance to swelling can be further increased by adding a suitable cross-linking agent to the aqueous solution of EVOH and cross-linking EVOH during the drying step. This method has some potential drawbacks, such as reduced EVOH solution stability in storage, reduced biodegradability and compostability of the composition, as well as introducing regulated chemical additives into the composition. The decision to use of such cross-linking additives strongly depends on the end-use application requirements. Typical cross-linking agents for EVOH include dialdehydes, i.e. glyoxal and glutaraldehyde, terephthalaldehyde, boric acid and/or sodium borate, citric acid, aluminum chloride, ammonium zirconium carbonate, potassium zirconium carbonate, zinc ammonia carbonate, and chromium stearate complex. The amounts of cross-linking agents added to the aqueous solution of EVOH generally range from about 0.1 wt. % to about 2.5 wt. % on a solid-on-solid basis.

In some embodiments, the basecoat resin comprises an ethylene content in a range of from about 0.1 mol. %, 0.5 mol. %, 1 mol. %, 1.5 mol. %, 2 mol. %, 2.5 mol. %, or 3 mol. % to about 3.5 mol. %, 4 mol. %, 4.5 mol. %, 5 mol. %, 5.5 mol. %, 6 mol. %, 6.5 mol. %, 7 mol. %, 7.5 mol. %, 8 mol. %, 8.5 mol. %, 9 mol. %, 9.5 mol. %, 10 mol. %, 10.5 mol. %, 11 mol. %, 11.5 mol. %, 12 mol. %, 12.5 mol. %, 13 mol. %, 13.5 mol. %, 14 mol. %, 14.5 mol. %, or 15 mol %. In some embodiments, the basecoat resin comprises an ethylene content in a range of from about 3 mol. %, to about 9 mol. %.

EVOH solubility in water depends on its ethylene content and its average molecular weight. For example, for intermediate molecular weights with a degree of polymerization of about 1,500-2,000, EVOH with 3-9 mol. % ethylene is soluble in water at up to 15-25 wt. %, depending on ethylenic content. For practical reasons of keeping the coating viscosity range within 100-800 cPs, which is preferred in commercial coating operations, 7-12 wt. % EVOH solutions work best as a basecoat. The solution preparation of water-soluble EVOH is similar to dissolving PVOH, except for a longer cooking time requirement.

In some embodiments, the basecoat solution comprises EVOH in an amount in a range of from about 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, or 5 wt. %, to about 5.5 wt. %, 6 wt. %, 6.5 wt. %, 7 wt. %, 7.5 wt. %, 8 wt. %, 8.5 wt. %, 9 wt. %, 9.5 wt. %, 10 wt. %, 10.5 wt. %, 11 wt. %, 11.5 wt. %, 12 wt. %, 12.5 wt. %, 13 wt. %, 13.5 wt. %, 14 wt. %, 14.5 wt. %, 15 wt. %, 15.5 wt. %, 16 wt. %, 16.5 wt. %, 17 wt. %, 17.5 wt. %, 18 wt. %, 18.5 wt. %, 19 wt. %, 19.5 wt. %, 20 wt. %, 20.5 wt. %, 21 wt. %, 21.5 wt. %, 22 wt. %, 22.5 wt. %, 23 wt. %, 23.5 wt. %, 24 wt. %, 24.5 wt. %, or 25 wt. %. In some embodiments, the basecoat solution comprises EVOH in an amount in a range of from about 5 wt. % to about 25 wt. %. In some embodiments, the basecoat solution comprises EVOH in an amount in a range of from about 15 wt. % to about 25 wt. %. In some embodiments, the basecoat solution comprises EVOH in an amount in a range of from about 7 wt. % to about 12 wt. %.

In some preferred embodiments, the basecoat resin comprises at least 98% hydrolyzed EVOH grades, and further preferably at least 99.5% hydrolyzed EVOH grades, with 3-9 mol. % ethylene content.

In some embodiments, the preparation steps include: (i) mixing an EVOH powder in 10-25° C. water until its fully dispersed, followed by (ii) heating and cooking at 93-97° C. for 1.5-2.5 hours, and then (iii) cooling while continuing mixing. Since PVOH/EVOH solutions are known to support microbial growth (bacteria, fungi, and various molds), a biocide is usually added to ensure the solution stability during extended storage. Typically, isothiazolin based biocides like methylisothiazolinone (MI), methylchloroisothiazolinone (MCI), benzisothiazolinone (BIT), octylisothiazolione (OIT), dichlorocthylisothiazolinone (DCOIT), as well as 1,2-dibromo-2,4-dicyanobutane, 2-bromo-2-nitropropane-1,3-diol, sorbic acid, benzoic acid, propionic acid, and salts thereof are used.

Like PVOH, water soluble EVOH has excellent film forming properties, and it can be applied at 1 to 25 g/m² dry coat weights or 1-20 μm dry coating thickness by most commercial coating methods. For comparison, uniform extruded thermoplastic films generally cannot be produced thinner than 15-25 μm. As another comparison, typical plastic films for packaging generally have a thickness in the range of at least 50-100 μm.

For dry coat weights heavier than 10-15 g/m² adding a plasticizer is recommended to improve EVOH film flexibility. The following plasticizers are typically used with EVOH/PVOH resins: glycerol, higher molecular weight polyols, a water-soluble polyethylene glycol, and propylene glycol. Adding 0.5-2 wt. % of glycerol on the dry EVOH weight basis is preferred for most applications that require the use of a plasticizer.

In some embodiments, the basecoat comprises EVOH in a dry coat weight in a range of from about 1 g/m², 1.5 g/m², 2 g/m², 2.5 g/m², 3 g/m², 3.5 g/m², 4 g/m², 4.5 g/m², or 5 g/m², to about 5.5 g/m², 6 g/m², 6.5 g/m², 7 g/m², 7.5 g/m², 8 g/m², 8.5 g/m², 9 g/m², 9.5 g/m², 10 g/m², 10.5 g/m², 11 g/m², 11.5 g/m², 12 g/m², 12.5 g/m², 13 g/m², 13.5 g/m², 14 g/m², 14.5 g/m², 15 g/m², 15.5 g/m², 16 g/m², 16.5 g/m², 17 g/m², 17.5 g/m², 18 g/m², 18.5 g/m², 19 g/m², 19.5 g/m², 20 g/m², 20.5 g/m², 21 g/m², 21.5 g/m², 22 g/m², 22.5 g/m², 23 g/m², 23.5 g/m², 24 g/m², 24.5 g/m², or 25 g/m². In some embodiments, the basecoat comprises EVOH in a dry coat weight in a range of from about 1 g/m² to about 25 g/m².

In some embodiments, the basecoat comprises a plasticizer in an amount, based on dry EVOH weight, in a range of from about 0.1 wt. %, 0.2 wt. %, 0.3 wt. %, 0.4 wt. %, or 0.5 wt. % to about 1 wt. %, 1.5 wt. %, 2 wt. %, 2.5 wt. %, 3 wt. %, 3.5 wt. %, 4 wt. %, 4.5 wt. %, or 5 wt. %. In some embodiments, the basecoat comprises a plasticizer in an amount in a range of from about 0.5 wt. % to about 2 wt. %.

In some embodiments, the basecoat comprises EVOH in a thickness in a range of from about 0.5 μm to about 25 μm. In some embodiments, the basecoat comprises EVOH in a thickness in a range of from about 1 μm to about 20 μm.

In some embodiments, the basecoat comprises EVOH in a thickness less than about 15 μm. In some embodiments, the basecoat comprises EVOH in a thickness in a range of from about 0.5 μm, 1 μm, 1.5 μm, 2 μm, 2.5 μm, 3 μm, 3.5 μm, 4 μm, 4.5 μm, or 5 μm, to about 5.5 μm, 6 μm, 6.5 μm, 7 μm, 7.5 μm, 8 μm, 8.5 μm, 9 μm, 9.5 μm, 10 μm, 10.5 μm, 11 μm, 11.5 μm, 12 μm, 12.5 μm, 13 μm, 13.5 μm, 14 μm, 14.5 μm, or 15 μm. In some embodiments, the basecoat comprises EVOH in a thickness in a range of from about 0.5 μm to about 15 μm.

Topcoat Layer.

It was discovered in the present disclosure that most water-based resin dispersions and emulsions cannot form a barrier layer with the thickness similar to the EVOH basecoat and achieve the WVTR comparable to the disclosed EVOH basecoat layer, especially if environmentally responsible formulations without chloro- and fluorochemicals and without extrusion-laminated polyolefin layers are considered. However, such dispersions and emulsions can be effectively used as topcoats over the EVOH basecoat to provide just enough water vapor barrier to keep the EVOH layer at or below 65% RH. The morphology of a dried dispersion or emulsion coating strongly depends on the resin melting temperature in relation to the drying process temperature. Regardless of the final topcoat morphology, the WVTR of the topcoat layer needs to be independently evaluated at the intended conditions of use to determine whether it will be able to provide the required RH reduction at the interface with the basecoat. The choice of a particular topcoat chemistry, binder and/or surfactant package, drying/curing conditions, and the effective topcoat layer thickness will determine its WVTR performance.

Another discovery of the present disclosure is overcoming the issue of the topcoat compatibility with the basecoat. Being water resistant, the dried EVOH basecoat generally exhibits poor wetting by most water-based polymer resin dispersions and emulsions. This poor wetting can lead to pinholes, nonuniform surface coverage, layer delamination, and other coating defects. Adding up to 2 wt. % of the EVOH solution to the topcoat dispersion/emulsion (on the solid-on-solid basis) was found to greatly improve the EVOH surface wetting and eliminate these defects. However, adding a higher percentage of EVOH tends to increase WVTR of the dried topcoat, and is therefore undesirable. It was found that the preferred EVOH addition range is 0.5-2.0 wt. %, with the most preferred range being 1.0-1.5 wt. %. These addition levels provide sufficient dried basecoat layer wetting for most variants of the disclosure, although the particular EVOH addition levels are not limited by these values and should be individually selected for each topcoat formulation.

In some embodiments, the topcoat comprises EVOH in an amount in a range of from about 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, or 5 wt. %, to about 5.5 wt. %, 6 wt. %, 6.5 wt. %, 7 wt. %, 7.5 wt. %, 8 wt. %, 8.5 wt. %, 9 wt. %, 9.5 wt. %, 10 wt. %. In some embodiments, the topcoat comprises EVOH in an amount in a range of from about 0.1 wt. % to about 5 wt. %. In some embodiments, the topcoat comprises EVOH in an amount in a range of from about 0.5 wt. % to about 2 wt. %. In some embodiments, the topcoat comprises EVOH in an amount in a range of from about 1 wt. % to about 1.5 wt. %.

In some embodiments, the topcoat layer comprises a water-based dispersion or emulsion of one or more polymers selected from the group consisting of polyesters, polyacrylates and acrylic copolymers, polyvinyl acetate, styrene-butadiene copolymers, polyhydroxyalkanoates, vinyl acetate-ethylene copolymers, and a water-based emulsion of paraffin and ester waxes.

In some embodiments, the topcoat layer includes an aqueous polymeric dispersion or emulsion, compatibilized with the base layer by adding a small percentage of ethylenically modified polyvinyl alcohol solution, and optionally an additive selected from the group consisting of a viscosity modifier, defoamer, pH regulator, release agent, slip agent, anti-blocking additive, crosslinker, and combinations thereof.

In some embodiments, the topcoat is present in a dry coat weight in a range of from about 0.5 g/m², 1 g/m², 1.5 g/m², 2 g/m², 2.5 g/m², 3 g/m², 3.5 g/m², 4 g/m², 4.5 g/m², or 5 g/m², to about 5.5 g/m², 6 g/m², 6.5 g/m², 7 g/m², 7.5 g/m², 8 g/m², 8.5 g/m², 9 g/m², 9.5 g/m², 10 g/m², 10.5 g/m², 11 g/m², 11.5 g/m², 12 g/m², 12.5 g/m², 13 g/m², 13.5 g/m², 14 g/m², 14.5 g/m², 15 g/m², 15.5 g/m², 16 g/m², 16.5 g/m², 17 g/m², 17.5 g/m², 18 g/m², 18.5 g/m², 19 g/m², 19.5 g/m², 20 g/m², 20.5 g/m², 21 g/m², 21.5 g/m², 22 g/m², 22.5 g/m², 23 g/m², 23.5 g/m², 24 g/m², 24.5 g/m², or 25 g/m². In some embodiments, the topcoat is present in a dry coat weight in a range of from about 3 g/m² to about 20 g/m².

Methods of Coating.

In many embodiments, the water vapor barrier coating composition is made and applied according to suitable methods known in the art. In some embodiments, the water vapor barrier coating composition is applied according to a method comprising applying a basecoat layer and applying a topcoat layer, wherein the basecoat layer is applied onto a fibrous substrate and subsequently dried before the topcoat layer is applied onto the basecoat layer and subsequently dried.

In some embodiments, the method of applying a basecoat layer of a water vapor barrier coating composition comprises (i) applying a basecoat solution comprising an aqueous solution of ethylenically modified polyvinyl alcohol to a fibrous substrate by utilizing a rod coater, size press, curtain coater, slot-die coater, blade coater, roll coater, air knife coater, knife over roll, rotogravure coater, flexographic press, or spray coating technique; and (ii) subsequently drying the basecoat solution to form the basecoat layer.

Generally, drying and curing conditions play an important role in the barrier performance of water-based coatings. Hot air drying or IR radiation drying at temperatures ranging from 110 to 125° C. are typically used to evaporate all water from the coatings and to cure the resin dispersion or emulsion of the topcoat layer. The actual drying temperatures and the duration of each drying step depend on the solids percentage in the coatings and the wet surface application rate (wet gsm).

In some embodiments, the basecoat solution is dried by exposure to hot air or infrared radiation heating or ultrasonic heating or photonic heating or a steam-heated drying roll heating/drying system, or combinations thereof at a temperature of at least 100° C., at least 105° C., at least 110° C., at least 115° C., at least 120° C., at least 125° C., at least 130° C., at least 135° C., at least 140° C., at least 145° C., or at least 150° C. In some embodiments, the basecoat solution is dried by exposure to hot air or infrared radiation heating or ultrasonic heating or photonic heating or a steam-heated drying roll heating/drying system, or combinations thereof at a temperature of at least 110° C. In some embodiments, the basecoat solution is dried by exposure to hot air or infrared radiation heating or ultrasonic heating or photonic heating or a steam-heated drying roll heating/drying system, or combinations thereof at a temperature of at least 125° C.

In some embodiments, the method of applying a topcoat layer of a water vapor barrier coating composition comprises (i) applying a topcoat dispersion or emulsion comprising an aqueous polymeric dispersion or emulsion to a basecoat layer by utilizing a rod coater, size press, curtain coater, slot-die coater, blade coater, roll coater, air knife coater, knife over roll, rotogravure coater, flexographic press, or spray coating technique; and (ii) subsequently drying and/or curing the topcoat dispersion or emulsion to form the topcoat layer.

In some embodiments, the topcoat dispersion or emulsion is dried and/or cured by exposure to hot air or infrared radiation heating or ultrasonic heating or photonic heating or a steam-heated drying roll heating/drying system, or combinations thereof at a temperature of at least 100° C., at least 105° C., at least 110° C., at least 115° C., at least 120° C., at least 125° C., at least 130° C., at least 135° C., at least 140° C., at least 145° C., or at least 150° C. In some embodiments, the topcoat dispersion or emulsion is dried and/or cured by exposure to hot air or infrared radiation heating or ultrasonic heating or photonic heating or a steam-heated drying roll heating/drying system, or combinations thereof at a temperature of at least 110° C. In some embodiments, the topcoat dispersion or emulsion is dried and/or cured by exposure to hot air or infrared radiation heating or ultrasonic heating or photonic heating or a steam-heated drying roll heating/drying system, or combinations thereof at a temperature of at least 125° C.

In some embodiments, provided herein is a method of applying a water vapor barrier coating composition, the method comprising (i) applying a basecoat solution comprising an aqueous solution of ethylenically modified polyvinyl alcohol to a fibrous substrate by utilizing a rod coater, size press, curtain coater, slot-die coater, blade coater, roll coater, air knife coater, knife over roll, rotogravure coater, flexographic press, or spray coating technique; (ii) subsequently drying the basecoat solution to form the basecoat layer; (iii) applying a topcoat dispersion or emulsion comprising an aqueous polymeric dispersion or emulsion to the basecoat layer by utilizing a rod coater, size press, curtain coater, slot-die coater, blade coater, roll coater, air knife coater, knife over roll, rotogravure coater, flexographic press, or spray coating technique; and (iv) subsequently drying and/or curing the topcoat dispersion or emulsion to form the topcoat layer.

In some embodiments, provided herein is a method of coating a fibrous substrate comprising the steps of (i) preparing of the two coating solutions, (ii) sequentially coating them onto the substrate, and (iii) drying each coating layer after application. In these embodiments, preparing the basecoat solution comprises the steps of (a) dispersing a EVOH resin powder in 15-25° C. water, (b) dissolving it by cooking the dispersion at 93-97° C. for at least 1.5 hours, (c) cooling the solution to ambient temperature, and (d) optionally adding and mixing in a biocide and/or a plasticizer. In these embodiments, preparing the topcoat dispersion or emulsion comprises the steps of (a) preparing a raw dispersion or emulsion using a powdered resin mixture or a liquid resin, a surfactant, and a binder resin package, (b) modifying the dispersion/emulsion with up to 2 wt. % (solids on solids basis) of 3-9 mol. % ethylene EVOH solution, and (c) optionally adding and mixing in a viscosity modifier additive, a defoamer, a pH regulator, a release agent, a slip agent, an anti-blocking additive, a crosslinker, or a combination thereof. For some polymeric dispersions/emulsions and surfactant/binder packages, where viscosity buildup is observed after adding the EVOH solution to them, additional water may be used to adjust the final coating viscosity.

In many embodiments, an additional heat treatment step of the finished coating composition and/or coated article at 150-200° C. for 2-10 minutes was found to further reduce the WVTR of the composition by 10-30% by apparently promoting crystallization of the EVOH basecoat layer. A 2-minute heat treatment at 150° C. and 170° C. was sufficient to observe a measurable WVTR reduction. A 5-10-minute heat treatment at 150° C. produced the maximum WVTR improvement without further reduction with time. A 5-10-minute heat treatment at 170° C. reduced the WVTR even more than the 5-10-minute heat treatment at 150° C. Longer heat treatments or using temperatures exceeding 200° C. were found to promote degradation of the EVOH resin, and therefore are undesirable.

In some embodiments, the water vapor barrier coating composition is heat treated after drying by exposure to temperatures of at least 125° C., at least 130° C., at least 135° C., at least 140° C., at least 145° C., at least 150° C., at least 155° C., at least 160° C., at least 165° C., at least 170° C., at least 175° C., at least 180° C., at least 185° C., at least 190° C., at least 195° C., or at least 200° C.

In some embodiments, the water vapor barrier coating composition is heat treated after drying for at least 0.5 minutes, at least 1 minute, at least 2 minutes, at least 3 minutes, at least 4 minutes, at least 5 minutes, at least 6 minutes, at least 7 minutes, at least 8 minutes, at least 9 minutes, or at least 10 minutes.

In some embodiments, the water vapor barrier coating composition is heat treated after drying by exposure to temperatures of at least 150° C. for at least 1 minute. In some embodiments, the water vapor barrier coating composition is heat treated after drying by exposure to temperatures of at least 170° C. for at least 1 minute. In some embodiments, the water vapor barrier coating composition is heat treated after drying by exposure to temperatures of at least 170° C. for at least 5 minutes.

Coated Articles.

In many embodiments, the water vapor barrier coating composition may be applied to any suitable substrate known in the art. In some embodiments, the water vapor barrier coating composition is applied to a fibrous or fiber-based substrate. In some embodiments, the water vapor barrier coating composition coats a fibrous substrate selected from the group consisting of paper, paperboard, molded fiber, molded starch, or other fibrous substrates. The fiber source of the substrates could come from, for example, wood pulp, bagasse, grass, bamboo, hemp, an agricultural fiber source, coated paper, paper coated with nanofiber cellulose, paper coated with microfibrillated cellulose, and combinations thereof.

In many embodiments, the substrate is pre-coated with any suitable coating known in the art. In some embodiments, the substrate is a pre-coated substrate. In some embodiments, the substrate is a pre-coated fibrous or fiber-based substrate. In some embodiments, the substrate is pre-coated on at least one side. In some embodiments, the substrate is pre-coated on a barrier side. In some embodiments, the substrate is pre-coated on a non-barrier side. In some embodiments, the substrate is pre-coated on a back side.

In some embodiments, the substrate is pre-coated with nanofiber cellulose, microfibrillated cellulose, or combinations thereof.

In many embodiments, a fiber-based packaging article is coated with the water vapor barrier coating composition. In some embodiments, the fiber-based packaging article is selected from the group consisting of a pouch film, a lidding film, a paperboard, a molded fiber, a molded starch container, and combinations thereof. Generally, the water vapor barrier coating composition reduces the water vapor transmission rate of the fiber-based packaging article.

In some embodiments, provided herein is a fiber-based packaging article, such as a pouch film, a lidding film, or a container, sequentially coated with the water vapor barrier coating composition comprising a basecoat and a topcoat as described above, wherein each coating is dried after application at the temperatures ranging from 110 to 125° C. In some embodiments, to achieve an additional reduction in the WVTR of the coating composition, the finished packaging article can be further subjected to a separate heat treatment step at the temperatures ranging from 150 to 200° C. for 1-10 minutes. Without being bound to any particular theory, this treatment is believed to progressively induce crystallization of the EVOH resin in the basecoat layer. This treatment was found to further reduce the WVTR of the coating composition by additional 10-30%.

Methods of Use.

In many embodiments, the water vapor barrier coating composition is used according to suitable methods known in the art. In some embodiments, the water vapor barrier coating composition is used to reduce a water vapor transmission rate of a substrate. In some embodiments, the water vapor barrier coating composition is used to reduce a water vapor transmission rate of an article, such as a fiber-based packaging article, according to a method comprising (i) applying the water vapor barrier coating composition to the article; and (ii) optionally heat treating the article.

Uses of the water vapor barrier coating composition according to the present disclosure include application to packaging articles for frozen, refrigerated, and/or ambient storage foods, pharmaceutical products, cosmetics, and/or other consumer goods that demand a high level of water vapor barrier protection during distribution and storage. With the present disclosure it becomes possible to replace plastic packaging with biodegradable and/or compostable paper-based packaging, thereby offering a comparable level of water vapor barrier performance. Biodegradability of ethylenically modified PVOH is similar to regular PVOH, therefore the basecoat layer of the disclosure is expected to pass most biodegradability testing protocols. The biodegradability and compostability of the topcoat layer of the present disclosure will depend on its chemistry and morphology. Biodegradability and compostability standards vary among jurisdictions, therefore the composition conformance to these standards should be tested and verified on the finished packaging articles with specific basecoat and topcoat weights on an individual case basis.

Water Vapor Transmission Rate.

The concept of water vapor transmission rate (WVTR, in g/m²/day or g/100 in²/day) and water vapor permeability (WVP, in g·mm/m²/day) dependence on RH is widely used in this disclosure. Since WVTR of an article (e.g. a film, layer, or structure) and WVP of a homogeneous material are explicitly defined for a specific RH difference across the article thickness or the material sample thickness, it is expressly understood that when the WVTR or WVP dependence on RH is mentioned, it means the WVTR or WVP dependence on the RH difference between the noted value and 0% RH. Hence when the WVTR of a certain composition is listed at 23° C. and 50% RH, it always means the WVTR value obtained at 50%-0% RH difference across the sample thickness:

WVTR at 50% RH=WVTR@(50%−0%)RH

When RH at the low RH side of the sample is not zero, the WVTR is always reported with specific high and low RH values, for example, as WVTR @ (90%−40%)RH. It is also understood that for materials with nonlinear WVP dependence on RH (in the described sense), the WVP of the material and WVTR of a uniform material film or layer will generally depend on the absolute RH values rather than just the RH difference, i.e. in general:

WVTR@(50%−0%)RH WVTR@(75%−25%)RH WVTR@(90%−40%)RH WVTR@(100%−50%)RH, and so on, even though the RH difference is the same (here ΔRH=50% for all listed conditions).

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever.

Example 1. The effect of the additional heat treatment step on the WVTR of the EVOH basecoat composition.

Substrate: A light weight unbleached paper with WVTR=54 g/100 in²/day at 23° C. and 50% RH.

Table 1 summarizes the effects of heat treatment of the EVOH basecoat alone. Each value is the average WVTR of duplicate samples, tested using the dry gravimetric cup WVTR method at 23° C. and 50% RH. The gravimetric method of measuring WVTR is described in ASTM E-96 and TAPPI T 448 om-17 standards.

TABLE 1
Comparison of WVTR of coated paper samples
before and after heat treatment.

| | EVOH | | Heat treated | WVTR after |
|---|---|---|---|---|
| | Basecoat | Topcoat | (at 150° C. | 114 hours |
| Sample | (dry g/m²) | (dry g/m²) | for 10 min) | (g/100 in²/day) |
| 1 | 2.9 | None | No | 0.65 |
| 2 | 2.9 | None | Yes | 0.50 (−23%) |
| 3 | 3.3 | None | No | 0.51 |
| 4 | 3.3 | None | Yes | 0.43 (−16%) |

Example 2. The effect of the additional heat treatment step on the WVTR of the EVOH basecoat/topcoat composition.

Substrate: A light weight unbleached paper with WVTR=54.0 g/100 in²/day at 23° C. and 50% RH.

Topcoat: WVTR of 15.9 gsm topcoat alone=5.45 g/100 in²/day at 23° C. and 50% RH.

Table 2 summarizes the effects of heat treatment on WVTR of the basecoat vs. the basecoat plus topcoat composition. Each value is the average WVTR of duplicate samples, tested using the dry gravimetric cup WVTR method at 23° C. and 50% RH.

TABLE 2
Comparison of WVTR of coated paper samples
before and after heat treatment.

| | EVOH | | Heat treated | WVTR after |
|---|---|---|---|---|
| | Basecoat | Topcoat | (at 170° C. | 115 hours |
| Sample | (dry g/m²) | (dry g/m²) | for 10 min) | (g/100 in²/day) |
| 1 | 5.1 | None | No | 0.30 |
| 2 | 5.1 | None | Yes | 0.26 (−13%) |
| 3 | 4.9 | 15.9 | No | 0.242 |
| 4 | 4.9 | 15.9 | Yes | 0.214 (−11.5%) |

Example 3. Typical application rates for the EVOH basecoat and the topcoat on fibrous substrates and their typical WVTR values.

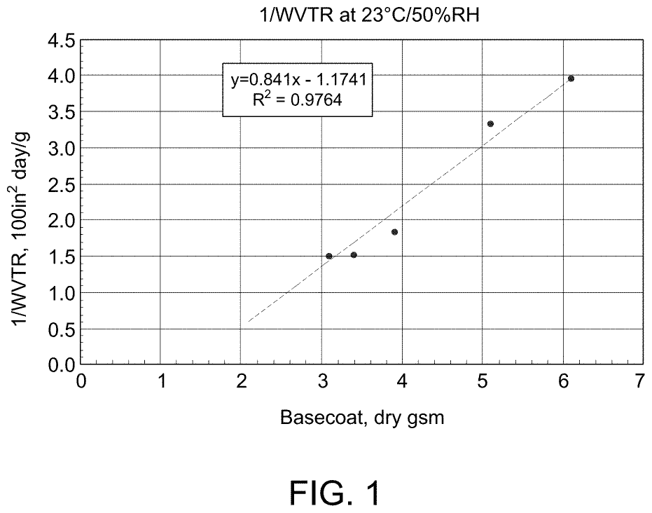

Extrapolation of the linear 1/WVTR trend line in FIG. 1 to its interception with the x-axis demonstrates that about 1.4 gsm of dry basecoat weight does not contribute to reducing WVTR (most likely spent on wetting surface fibers of the paper). The measured WVTR is inversely proportional to the dry EVOH coat weight above 1.4 gsm. The 1.4 gsm “fiber wetting” value is specific to the paper substrate used in the example, and it will be different for other substrates with different porosity and fiber type. Therefore, it needs to be independently evaluated for any specific substrate.

From FIG. 1, approximately 2.5 dry gsm basecoat application is required to obtain WVTR=1.0 g/100 in²/day at 23° C. and 50% RH. To obtain WVTR=0.3 g/100 in²/day at 23° C. and 50% RH, approximately 5.1 dry gsm basecoat application is required. For comparison, about 14 gsm of extrusion-laminated low density polyethylene (LDPE) film application is necessary to achieve the same WVTR.

Topcoat application rates depend on the topcoat chemistry, WVTR after curing, intended conditions of use, and process and end use requirements. Typically, 3-20 dry gsm of the topcoat is applied on the basecoat, although this range is not intended to be limiting the disclosure and it will depend on specific application requirements.

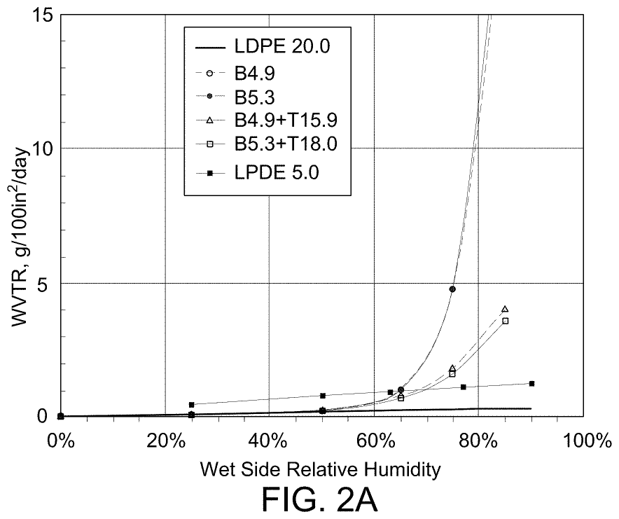

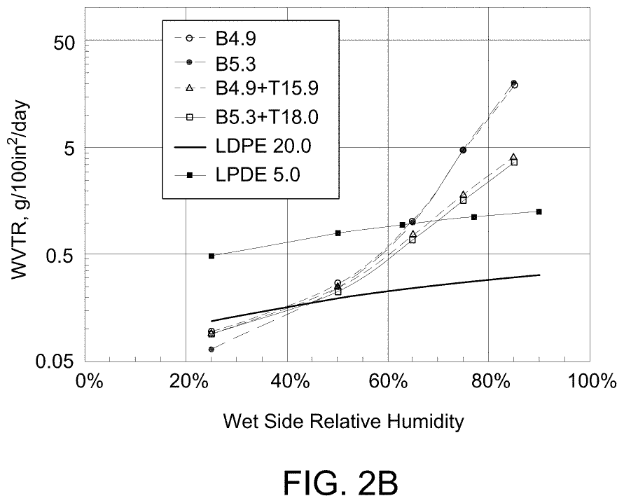

The overall surface coverage of the composition as described typically varies from 5 to 20 dry gsm, which corresponds to the effective thickness of the composition of about 4-16 μm. This favorably compares to typical extruded film applications with 15-25 μm and higher thickness. Despite lower application rates, the described composition has WVTR values comparable or lower than that of extruded polyethylene and polypropylene films for a wide range of RH values (depending on the water vapor barrier provided by the topcoat), as shown in FIG. 2B.

Example 4. Synergistic effect of the basecoat/topcoat combination on the WVTR.

The light weight unbleached paper with WVTR=54 g/100 in²/day at 23° C. and 50% RH was coated with the EVOH basecoat at 4.9 and 5.3 dry gsm (marked as B4.9 and B5.3 in FIGS. 2A and 2B) and then topcoated with a polyester dispersion modified with 2 wt. % EVOH at 15.9 and 18.0 dry gsm (marked as T15.9 and T18.0). The WVTR of the paper with basecoat alone and WVTR of the paper with both basecoat and topcoat were measured using the dry gravimetric cup method at 25%, 50%, 65%, 75%, and 85% RH on the coated side and 0% RH on the paper side. For comparison, known experimental WVTR data for 20 gsm LDPE coating on paper are provided (marked as LDPE 20.0) as well as calculated WVTR values for 5 gsm LDPE film (marked as LDPE 5.0) (Lahtinen et al., Prediction of WVTR with General Regression Models, TAPPI European PLACE Conference, January 2007). The results are shown in FIG. 2A with linear y-axis scaling and FIG. 2B with logarithmic y-axis scaling.

At 50% RH a minor WVTR improvement is expected from the topcoated sample, because the EVOH basecoat is not exposed to RH>65% and its water vapor barrier properties are not compromised. Using 50% RH to 0% RH WVTR data, the overall WVTR TR₀ of the composition can be found from the well-known series resistance formula, using the known WVTR values for the basecoat (TR_{B}) and topcoat (TR_{T}):

$$\frac{1}{{TR}_{0}} = \frac{1}{{TR}_{B}} + \frac{1}{{TR}_{T}} \qquad ( 1 )$$

The series resistance formula is generally valid for multilayer systems with uniform homogeneous layers where the WVTR of each individual layer linearly depends on the RH difference across the layer. The measured transmission rates are:

TR_{B}=0.264 g/100 in²/day at 23° C. and 50% RH for 4.9 gsm EVOH basecoat.

TR_{T}=5.45 g/100 in²/day at 23° C. and 50% RH for 15.9 gsm topcoat.

Then the expected TR_{B}=0.252 g/100 in²/day at 23° C. and 50% RH, and the actual measured WVTR:

TR_{0.m}=0.242 g/100 in²/day at 23° C. and 50% RH, i.e. 4% reduction below the expected value of 0.252.

At 75% RH a large improvement is expected due to the synergistic effect of the topcoat on the basecoat WVTR. Using 75% RH to 0% RH WVTR data, the overall WVTR TR₀ of the composition is found from the same series resistance formula (1).

TR_{B}=4.74 g/100 in²/day at 23° C. and 75% RH for 4.9 gsm EVOH basecoat.

TR_{T}=6.60 g/100 in²/day at 23° C. and 75% RH for 15.9 gsm topcoat.

Then the expected TR_{0.m}=2.76 g/100 in²/day at 23° C. and 75% RH, however the actual measured WVTR of the composition:

TR_{0.m}=1.80 g/100 in²/day at 23° C. and 75% RH, i.e. it is 35% lower than the theoretical value of 2.76.

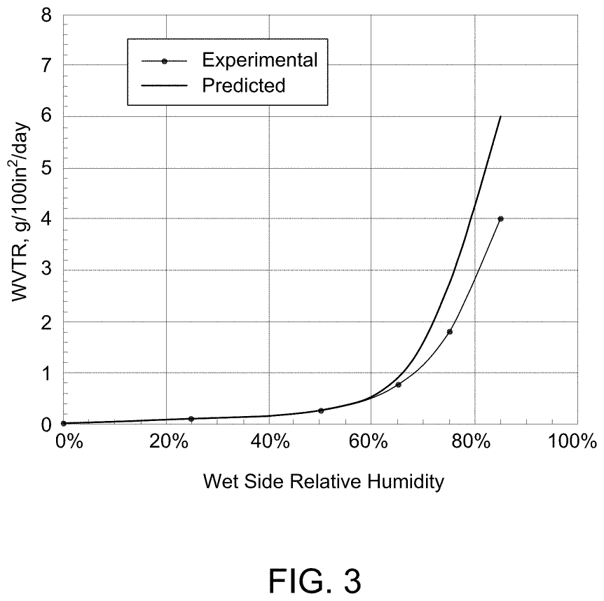

FIG. 3 depicts the observed WVTR of the disclosed composition vs. RH and shows how it differs from the theoretical values, predicted using the series resistance formula. No difference between theoretical and experimental WVTR values is observed below 65% RH, however, above 65% RH the composition WVTR is about 35% below the predicted values.

Example 5. The WVTR performance of the basecoat layer vs. the basecoat plus topcoat composition at refrigerated conditions.

Substrate: A light weight unbleached paper with WVTR=54.0 g/100 in²/day at 23° C. and 50% RH

Topcoat: WVTR of 15.9 gsm topcoat alone=5.45 g/100 in²/day at 23° C. and 50% RH

The coated paper samples were mounted in the gravimetric cups, filled with desiccant, with the coated side facing up, and were placed in a refrigerator set at +6° C. and 80% RH. The weight gain was monitored daily until the steady state was reached. Each value is the average WVTR of triplicate samples, tested using the dry gravimetric cup WVTR method at 6° C. and 80% RH.

TABLE 3
Comparison of WVTR of coated paper samples at +6° C.
and 80% − 0% RH difference across the sample.

| | EVOH | | WVTR after |
|---|---|---|---|
| | Basecoat | Topcoat | 137 hours |
| Sample | (dry g/m²) | (dry g/m²) | (g/100 in²/day) |
| 1 | 4.9 | None | 1.38 |
| 2 | 4.9 | 15.9 | 0.46 (−67%) |
| 3 | 5.3 | None | 1.58 |
| 4 | 5.3 | 18.0 | 0.41 (−74%) |

Based on the individual layer WVTR values and using the calculation in Example 4, the topcoat layer is expected to provide about 41% reduction for the basecoat layer WVTR. However, due to synergistic effects of the topcoat on the basecoat and reducing RH levels the EVOH basecoat is exposed to, the actual WVTR of the claimed composition is reduced by 67-74% compared to the basecoat alone.

Example 6. Calculating the required thickness of a specific topcoat formulation to keep the basecoat layer at or below 65% RH exposure at the conditions of use.

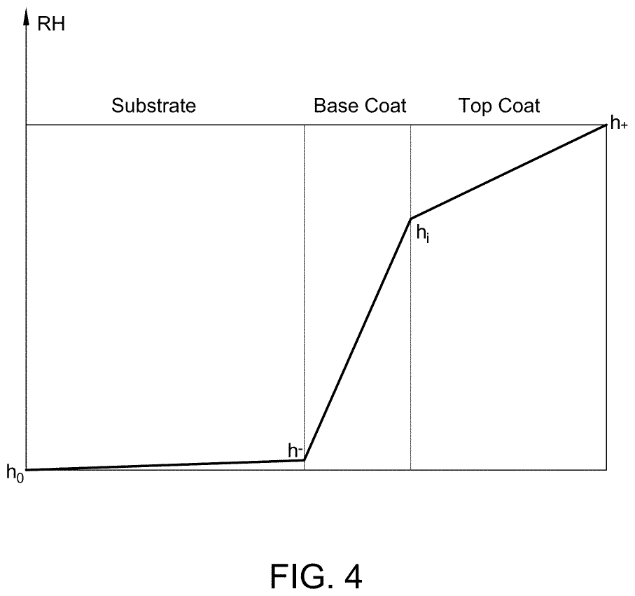

In FIG. 4, h₊ is the known RH in the high humidity environment (e.g. interior of the food package), h₀ is the known RH in the low humidity environment (e.g. ambient or refrigerated storage environment). Since the substrate—provides a negligible water vapor barrier (i.e. a very high WVTR), we consider h₋ at the substrate—basecoat interface to be approximately equal to h₀: h₋≈h₀. We also assume that h₊>65% and h₋<65%. hᵢ is the unknown RH at the basecoat—topcoat interface. r_{B} is WVTR of the basecoat at a given temperature and 50%−0% RH difference, r_{T} is WVTR of the topcoat at a given temperature and 50%−0% RH difference.

In the steady state, the water vapor flux F (in g/m²/day) across any cross section parallel to the coated substrate surface at temperature T is the same:

F(g/m²/day)=F_{B}=F_{T} (2)

In other words, fluxes across the basecoat (F_{B}) and the topcoat (F_{T}) are equal. If WVTR's r_{B} and r_{T} linearly depend on RH, then:

F_{B}=r_{B}@(hᵢ−h₀); F_{T}=r_{T}@(h₊−hᵢ)

It is assumed that both layers in the composition have WVTR's linearly dependent on RH (since the EVOH base layer is intended to be maintained at 65% RH and below, it will also have an approximately linear dependence of WVTR on RH). Then the corresponding WVTR values can be related to the known WVTR's at standard test conditions as:

r_{B}@(hᵢ−h₀)=r_{B}@(50%−0%)RH·(hᵢ−h₀)/50%

r_{T}@(h₊−hᵢ)=r_{T}@(50%−0%)RH·(h₊−hᵢ)/50%

Thr r_{B}@ (50%−0%)RH and r_{T}@(50%−0%)RH above are the values r_{B} and r_{T}, respectively, known from the independent WVTR testing. Therefore:

r_{B}(hᵢ−h₀)=r_{T}(h₊−hᵢ)

After solving for hᵢ, the following is obtained:

$${h}_{i} = \frac{{r}_{B} {h}_{0} + {r}_{T} {h}_{+}}{{r}_{B} + {r}_{T}} \qquad ( 3 )$$

Or, alternatively, if it is desired to maintain a certain hᵢ value, e.g. hᵢ=65%, then the required WVTR of the topcoat: r_{T}@(50%−0%)RH can be found as

$${r}_{T} = {r}_{B} \frac{{h}_{i} - {h}_{0}}{{h}_{+} - {h}_{i}} \qquad ( 4 )$$

For example, for r_{B}=0.6 g/100 in²/day at temperature T and 50% RH, h₊=80%, hᵢ=65%, h₀=0%, the r_{T} value at temperature T and 50% RH is found as:

$${r}_{T} = 0.6 \frac{65 \% - 0 \%}{80 \% - 65 \%} = 2.6 g / 100 {in}^{2} / day$$

In some embodiments, it may not be necessary or feasible to maintain the interfacial RH hᵢ at 65% RH or lower throughout the entire EVOH basecoat layer. If the topcoat layer materials cannot provide the required low WVTR at a technically and commercially reasonable coat weight (thickness), then the EVOH basecoat thickness can be increased to provide a higher water vapor barrier than the minimum application requirement. In this case, some portion of that thickness, adjacent to the topcoat layer, may be exposed to higher RH values and will serve as an extension of the topcoat, by protecting the remaining basecoat sublayer and keeping it below 65% RH. In some embodiments, this could be the most cost effective and practical design, which optimizes the overall thickness of the composition by balancing the basecoat and the topcoat weights in the described manner.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where an disclosure or a portion thereof is defined with an open-ended term such as “comprising,” it should be readily understood that (unless otherwise stated) the description should be interpreted to also describe such an disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A water vapor barrier coating composition comprising
a basecoat layer comprising a dried aqueous solution of ethylenically modified polyvinyl alcohol; and
a topcoat layer comprising a dried aqueous polymeric dispersion or emulsion.

2. The water vapor barrier coating composition of claim 1, wherein the basecoat layer comprises
a dried aqueous solution of water-soluble ethylene-vinyl alcohol copolymer with at least 98% degree of hydrolysis, containing 3-9 mol. % of ethylene;
optionally a crosslinker;
optionally a biocide; and
optionally a plasticizer.

3. The water vapor barrier coating composition of claim 2, wherein the plasticizer is selected from the group consisting of glycerol, a polyol having a higher molecular weight than glycerol, a water-soluble polyethylene glycol, and propylene glycol.

4. The water vapor barrier coating composition of claim 1, wherein the basecoat layer is dried by exposure to hot air or infrared radiation heating or ultrasonic heating or photonic heating or a steam-heated drying roll heating/drying system, or combinations thereof at a temperature of at least 110° C.

5. The water vapor barrier coating composition of claim 1, wherein the topcoat layer comprises a dried water-based dispersion or emulsion of one or more polymers selected from the group consisting of polyesters, polyacrylates and acrylic copolymers, polyvinyl acetate, styrene-butadiene copolymers, polyhydroxyalkanoates, vinyl acetate-ethylene copolymers, and a water-based emulsion of paraffin and ester waxes.

6. The water vapor barrier coating composition of claim 5, wherein the dried water-based dispersion or emulsion is modified with up to 2 wt. %, on solid-on-solid basis, of a solution comprising
an aqueous solution of water-soluble ethylene-vinyl alcohol copolymer with at least 98% degree of hydrolysis, containing 3-9 mol. % of ethylene;
optionally a crosslinker;
optionally a biocide; and
optionally a plasticizer.

7. The water vapor barrier coating composition of claim 6, wherein the topcoat layer is dried by exposure to hot air or infrared radiation heating or ultrasonic heating or photonic heating or a steam-heated drying roll heating/drying system, or combinations thereof at a temperature of at least 110° C.

8. The water vapor barrier coating composition of claim 6, wherein the topcoat layer has a water vapor transmission rate (WVTR) for a specific uniform single layer thickness at the conditions of use, is applied at the dry surface coverage in g/m² or at the dry layer thickness in micrometers, and is exposed to a high RH environment;
wherein the thickness is selected to reduce relative humidity at the basecoat layer interface with the topcoat layer to at least 65% or lower.

9. The water vapor barrier coating composition of claim 1, wherein the composition is heat treated after drying by exposure to temperatures of at least 150° C. for at least 1 minute.

10. The water vapor barrier coating composition of claim 1, wherein the composition is heat treated after drying by exposure to temperatures of at least 170° C. for at least 1 minute.

11. The water vapor barrier coating composition of claim 1, wherein the fibrous substrate is selected from the group consisting of paper, paperboard, molded fiber, molded starch, wood pulp, bagasse, grass, bamboo, hemp, an agricultural fiber source, coated paper, paper coated with nanofiber cellulose, paper coated with microfibrillated cellulose, and combinations thereof.

12. A fiber-based packaging article coated with the coating composition of claim 1.

13. The fiber-based packaging article of claim 12, wherein the fiber-based packaging article is selected from the group consisting of a pouch film, a lidding film, a paperboard, a molded fiber, and a molded starch container.

14. A water vapor barrier coating composition comprising
a basecoat layer comprising ethylenically modified polyvinyl alcohol; and
a topcoat layer comprising a polymer;
wherein the water vapor barrier coating composition is prepared according to a method comprising
applying an aqueous solution of ethylenically modified polyvinyl alcohol onto a fibrous substrate;
drying the aqueous solution to form the basecoat layer;
applying an aqueous polymeric dispersion or emulsion onto the basecoat layer; and
drying the aqueous polymeric dispersion or emulsion to form the topcoat layer.

15. A method of applying a basecoat layer of a water vapor barrier coating composition, the method comprising
applying a basecoat solution comprising an aqueous solution of ethylenically modified polyvinyl alcohol to a fibrous substrate by utilizing a rod coater, size press, curtain coater, slot-die coater, blade coater, roll coater, air knife coater, knife over roll, rotogravure coater, flexographic press, or spray coating technique; and
subsequently drying the basecoat solution with hot air or infrared radiation or ultrasonic heating or photonic heating or a steam-heated drying roll heating/drying system, or combinations thereof at a temperature of at least 110° C. to form the basecoat layer.

16. The method of applying a basecoat layer of a water vapor barrier coating composition of claim 15, wherein the method comprises drying the basecoat solution with hot air or infrared radiation or ultrasonic heating or photonic heating or a steam-heated drying roll heating/drying system, or combinations thereof at a temperature of at least 125° C. to form the basecoat layer.

17. A method of applying a topcoat layer of a water vapor barrier coating composition, the method comprising
applying a basecoat layer of a water vapor barrier coating composition according to the method of claim 15;
applying a topcoat dispersion or emulsion comprising an aqueous polymeric dispersion or emulsion to the basecoat layer by utilizing a rod coater, size press, curtain coater, slot-die coater, blade coater, roll coater, air knife coater, knife over roll, rotogravure coater, flexographic press, or spray coating technique; and
subsequently drying the topcoat dispersion or emulsion with hot air or infrared radiation or ultrasonic heating or photonic heating or a steam-heated drying roll heating/drying system, or combinations thereof at a temperature of at least 110° C. to form the topcoat layer.

18. The method of applying a topcoat layer of a water vapor barrier coating composition of claim 17, wherein the method comprises drying the topcoat dispersion or emulsion with hot air or infrared radiation or ultrasonic heating or photonic heating or a steam-heated drying roll heating/drying system, or combinations thereof at a temperature of at least 125° C. to form the topcoat layer.

19. A method of reducing the water vapor transmission rate of the fiber-based packaging article of claim 13, the method comprising heat treating the article by exposing the article to a temperature of at least 150° C. for at least 1 minute.

20. A method of reducing the water vapor transmission rate of the fiber-based packaging article of claim 13, the method comprising heat treating the article by exposing the article to a temperature of at least 170° C. for at least 1 minute.
